(19) United States
(12) Patent Application Publication
(10) Pub. No.: US 2026/0197322 A1
(43) Pub. Date: Jul. 9, 2026

(54) FINE GRAINED ACCESS TO SYSTEM RESOURCES

(71) Applicant: International Business Machines Corporation, Armonk, NY (US)

(72) Inventor: Shrinivas Kulkarni, Bangalore (IN)

(21) Appl. No.: 19/011,186

(22) Filed: Jan. 6, 2025

(51) Int. Cl. H04L 9/40

(52) U.S. Cl. CPC H04L 63/105; H04L 63/102

(57) ABSTRACT

A method, according to one approach, includes: receiving, at a base server from a connector, an access request originating from a user. The access request includes an authenticated user identification correlated with the user. The received access request is evaluated, and target resources are determined. Moreover, a determination is made as to whether the user is permitted to access the target resources. In response to determining that the user is permitted to access the target resources, the authenticated user identification and credentials of a second server storing the target resources are used to create an access signature. Furthermore, the access signature and the access request are transferred to the second server having the target resources.

### BACKGROUND

The present invention relates to verifying access, and more specifically, this invention relates to implementing fine grained access to resources.

Electronic documents (or digital files) have a number of benefits compared to physical documents. For instance, electronic documents are easier to store and access in comparison to physical documents. Electronic documents, especially in the form of verifiable credentials, can be electronically verified to ensure they have not been altered, to determine whether they have been signed by an authorized party, to inspect whether they have expired, to determine whether the documents have been revoked, etc. Also, depending on the format of an electronic document, certain portions of the electronic document may be adjusted to maximize privacy. In contrast, the process of accessing a physical document involves manually searching each document in a collection until the desired document is found, while multiple electronic documents can be automatically compared against one or more keywords.

Moreover, electronic documents can be uploaded from and/or downloaded to any device connected to a network, while tangible documents (e.g., papers) must be physically transported between locations. Similarly, electronic documents take up much less space than their physical counterparts. As a result, an increasing amount of physical material has been digitized.

While logical elements (e.g., electronic or digital documents) are easier to store and access than their physical counterparts, the process of verifying authenticity of electronic documents has been impacted. For example, accessing objects in a secure object storage involves providing credentials. Some credentials may work across different types of object storage, but often credentials include sensitive information that cannot be openly shared. As a result, conventional servers are unable to offer fine grained access control and cannot restrict certain users to only certain resources in specific servers.

### SUMMARY

A method, according to one approach, includes: receiving, at a base server from a connector, an access request originating from a user. The access request includes an authenticated user identification correlated with the user. The received access request is evaluated, and target resources are determined. Moreover, a determination is made as to whether the user is permitted to access the target resources. In response to determining that the user is permitted to access the target resources, the authenticated user identification and credentials of a second server storing the target resources are used to create an access signature. Furthermore, the access signature and the access request are transferred to the second server having the target resources.

A computer program product, according to another approach, includes: one or more computer readable storage media. The computer program product also includes program instructions that are stored on the one or more storage media to perform the foregoing method.

A computer system, according to yet another approach, includes: a processor set, and one or more computer readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3 is a flowchart of a method, in accordance with one approach.

FIG. 4 is a partial representational view of a distributed system configured to process access requests, in accordance with an in-use example.

### DETAILED DESCRIPTION

The following description is made for the purpose of illustrating the general

principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for processing access requests to resources at specific locations without receiving any credentials and/or configuration information associated with the resources themselves. Approaches herein thereby involve dynamically evaluating and verifying access requests that lack any sensitive information (e.g., storage location, security protocols, password(s), etc.) associated with the resources and/or where they are stored, e.g., as will be described in further detail below.

In one general approach, a method includes: receiving, at a base server from a connector, an access request originating from a user. The access request includes an authenticated user identification correlated with the user. The received access request is evaluated, and target resources are determined. Moreover, a determination is made as to whether the user is permitted to access the target resources. In response to determining that the user is permitted to access the target resources, the authenticated user identification and credentials of a second server storing the target resources are used to create an access signature. Furthermore, the access signature and the access request are transferred to the second server having the target resources.

In another general approach, a computer program product includes: one or more computer readable storage media. The computer program product also includes program instructions that are stored on the one or more storage media to perform the foregoing method.

In yet another general approach, a computer system includes: a processor set, and one or more computer readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as new access code in block 150 for processing access requests to resources at specific locations without receiving any credentials and/or configuration information associated with the resources themselves. Approaches herein thereby involve dynamically evaluating and verifying access requests that lack any sensitive information (e.g., storage location, security protocols, password(s), etc.) associated with the resources and/or where they are stored, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

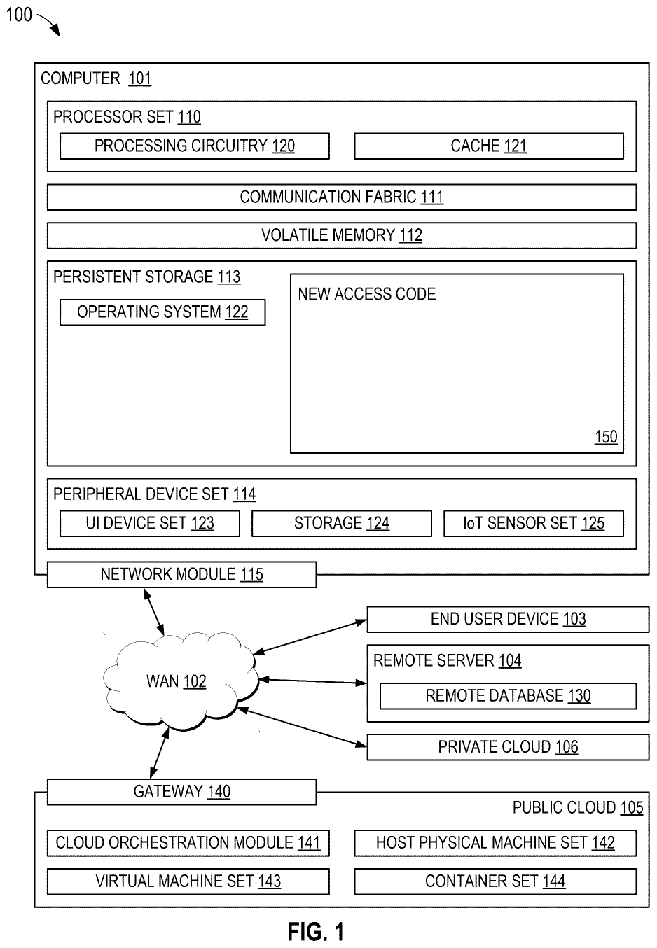

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a CPU, an integrated circuit (IC), a graphics processing unit (GPU), etc.

Of course, this logic may be implemented as a method on any device and/or system or as a computer program product, according to various approaches.

In order to access objects in a secure object storage bucket that is compatible with a given system (e.g., operating system), credentials are involved. Some credentials may work across different types of object storage, but often credentials include sensitive information that cannot be openly shared. For example, some credentials include public information (e.g., an access key) as well as private information (e.g., a secret key) that cannot be exposed. Some object stores also support additional credentials, while some object stores provide authentication based on the credentials. For example, access control is typically determined at bucket level rather than at the level of individual objects that are in a bucket.

For instance, conventional servers do not offer fine grained access control and cannot restrict certain users to only certain resources in specific servers. Thus, a service credential capable of accessing a resource on a conventional server is able to access any of the resources of the server, leading to significant security risks and issues with maintaining system operation.

This has given rise to situations where an application is relied on to access certain objects of a bucket. However, the credentials that are associated with accessing object stores are often private and preferably not openly shared. It is also important to ensure that users are only given access to resources (e.g., objects) they are authorized to utilize. For example, in the context of a lake house solution the credentials of an object storage bucket may be stored in the control plane of the lake house. Applications that are run function by accessing objects in the object store buckets, and bucket credentials are involved in this process of accessing data in the buckets. However, it is undesirable in some approaches that bucket credentials are exposed to certain users, applications, etc. In such situations, if the object storage does not support alternative authentication mechanisms, e.g., such as IAM token, there is no way for certain resources to be securely accessed.

In sharp contrast to these conventional shortcomings, approaches herein are desirably able to establish and maintain verified access to resources without unduly exposing credentials. As used herein, the term “credentials” refers to any distinctive information that may be used to prove the identity of a source and/or convey contextual information associated therewith. According to a non-limiting example, credentials may include a hash message authentication code (HMAC) that works across different types of object storages. The HMAC involves two pieces—an access key and a secret key. Some object stores also support additional credentials, while some object stores further provide authentication based on the credentials. Some approaches herein are able to achieve this fine grained access control outlining who/what is permitted to access each resource, along with other details, e.g., such as when the access is permitted. This access control may be converted into one or more access, security, data retention, etc., policies. In some approaches, each “policy” includes an AI based model that has been trained to evaluate input conditions and automatically generate determinations on how they should be addressed.

Some approaches herein are able to restrict access to certain objects (e.g., files) in a bucket and/or portions of a given object (for example, bytes 129-512 of an object). Some approaches include a secondary system (e.g., other than the object storage itself) that is configured to authorize what a particular application running on a user's processing device is able to access. Approaches herein are also able to achieve this functionality without implementing significant changes to existing client code and/or the object store itself that is hosting the objects. Rather, approaches herein are able to achieve data access and/or data write requests in a highly efficient manner by providing and verifying credentials behind the scenes to access the resources. As a result, no systems serve as bottlenecks and approaches herein are able to improve compute throughput, memory access latency, network bandwidth, etc., e.g., as will be described in further detail below.

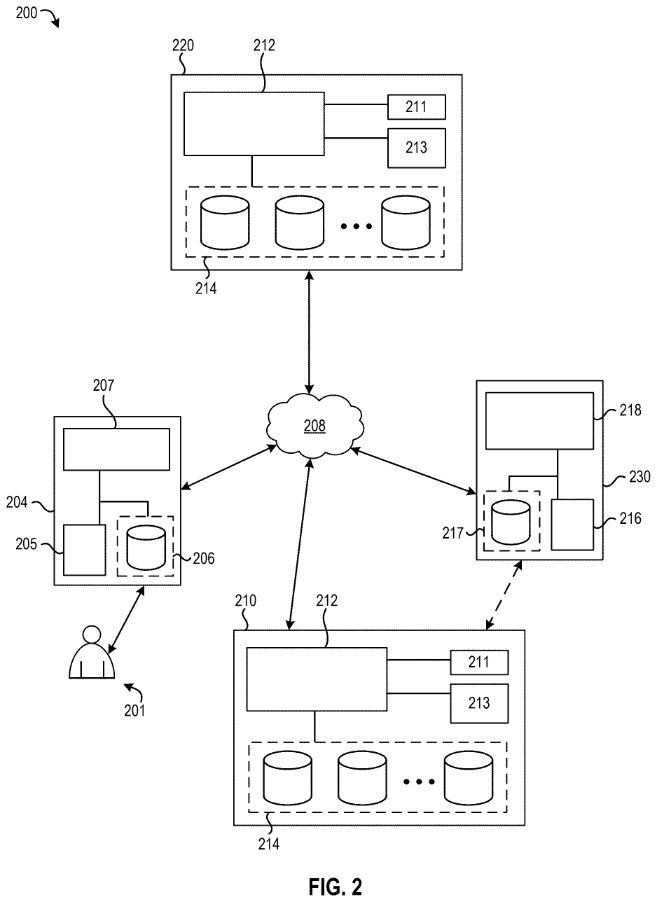

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a user 201 that is connected to a connector module 204. While FIG. 2 shows user 201 as being directly connected to the connector module 204 (e.g., over a physical electrical connection), the user 201 may be connected to (e.g., in communication with) the connector module 204 over one or more networks (not shown). The connector module 204 includes a processor 205, memory 206, and verification module 207. The connector module 204 may thereby receive access requests from user 201 and direct them. In some approaches, the verification module 207 may inspect access requests received from user 201 or over network 208, for credentials to determine whether the access requests have been issued correctly and remain accurate. In situations where credentials are determined to have been correctly issued and still accurate, a verification may be provided which authenticates the credentials for application.

The connector module 204 may thereby be configured to prevent a user, application, program, model, etc. from directly accessing the base server 210 and/or the second server 220. In other words, the connector module 204 may be configured to restrict access to resources, unless verification is made. For instance, the connector module 204 may route an access request to resources in the second server 220 in response to receiving the resource service credentials and the actual request containing the resource URI along with query parameters (e.g., expressions). However, access requests that do not include credentials may be sent to base server 210 for evaluation. There, the base server 210 may use the received information, along with information received from policy engine 230, to create an access signature for verified requests. The base server 210 may thereby send the signature along with the request to the target server 220 through the connector module 204. In response to the target server 220 identifying the valid access signature, the user 201 is returned the contents of the resource(s) and/or sub-resource(s). Different software systems use different connectors that may be configured to follow these protocols.

The connector module 204 is in turn connected to network 208. First and second servers 210, 220 respectively are also connected to network 208, along with policy engine 230. The network 208 may be of any type, e.g., depending on the desired approach. For instance, in some approaches the network 208 is a WAN, e.g., such as the Internet. However, an illustrative list of other network types which network 208 may implement includes, but is not limited to, a LAN, a PSTN, a SAN, an internal telephone network, etc. As a result, any desired information, data, commands, instructions, responses, requests, etc., may be sent between the connector module 204, servers 210, 220, and/or policy engine 230, regardless of the amount of separation which exists therebetween, e.g., despite being positioned at different geographical locations.

However, it should also be noted that two or more of the connector module 204, servers 210, 220, and/or policy engine 230 may be connected differently depending on the approach. According to an example, which is in no way intended to limit the invention, a server and policy engine may be located relatively close to each other and connected by a wired connection, e.g., a cable, a fiber-optic link, a wire, etc. ; etc., or any other type of direct connection which would be apparent to one skilled in the art after reading the present description.

While each of the connector module 204, servers 210, 220, and policy engine 230 are shown as being connected to a same network 208, it should be noted that information may be sent between the locations of system 200 differently depending on the implementation. According to an example, which is in no way intended to limit the invention, a verified access channel corresponding to a credential and/or policy verification procedure may be formed between user 201 and server 220 holding resources desired by the user 201. For example, servers 210, 220 may include text, media, binaries, trained models, etc., or any other access controlled resources that may be used to perform a data access request. This verified access channel may be formed in response to base server 210 generating an access signature and causing it to be routed to the location of a resource desired by a requesting user, e.g., as will be described in further detail below.

Referring still to FIG. 2, the servers 210, 220 are shown as having similar configurations. For example, servers 210, 220 include a large (e.g., robust) processor 212 coupled to a cache 211, a machine learning module 213, and a data storage array 214 having a relatively high storage capacity. Each of the servers 210, 220 may thereby include a collection of resources therein. For instance, server 210 and/or 220 may include one or more applications, trained artificial intelligence (AI) based models, virtual machines, hypervisors, etc. which are stored and implemented in cache 211, the machine learning module 213, and/or the data storage array 214. Access may further be selectively provided to these resources. For instance, access requests determined as meeting one or more predetermined criteria may be classified as being authorized and permitted to be performed.

These predetermined criteria may be organized into one or more policies which are maintained and applied by the policy engine 230. For instance, the policy engine 230 may include one or more machine learning models that are trained using various details about users (e.g., such as resource access patterns, authorization level(s), source location, etc.) as well as physical and/or logical resources that are available to at least some of the users (e.g., such as application authorization profiles, security parameters, access requirements, etc.). The machine learning models may thereby be used to evaluate details of users requesting access to resources, make comparisons with one or more access policies, and generate signatures that enable access to resources for respective users determined as being authorized (e.g., verified) to gain access. Providing these signatures to a target location (e.g., server) having the desired resources allows for users to gain access to logical and/or physical components without having any exposure to the credentials that allow for the access to be achieved. In other words, approaches are able to establish and maintain secure access to resources while keeping sensitive information (e.g., private keys) protected from unwanted exposure, e.g., as will be described in further detail below.

The policy engine 230 includes a processor 216 coupled to memory 217 and an AI module 218. The AI module 218 may include one or more AI based models that have been trained to inspect resource access requests that are received to determine whether they are issued from sources (e.g., users) that are permitted (e.g., authorized, predetermined, etc.) to access the resources being requested. For instance, in situations where a user has issued a request to use a first resource held in a first server, the AI based models may determine details about the user (e.g., by evaluating past performance, inspecting available metadata, evaluating an access signature, etc.) and compare the user details to one or more policies to determine whether the user is permitted to actually access the requested resources, e.g., as will be described in further detail below. The memory 217 may thereby be used to store data corresponding to credentials that have been issued to various users, as well as related information. Moreover, memory 217 may include different types of memory. According to examples, which are in no way intended to limit the invention, the policy engine 230 may include hard disk drives, solid state memory modules, etc.

It follows that the different electronic devices in system 200 may have different performance capabilities. As noted above, the base server 210 may be configured to receive access requests from users (e.g., user 201) and communicate directly (e.g., see dashed arrowed line) with the policy engine 230 in order to determine whether each access request should be satisfied. The base server 210 is thereby able to evaluate each access request using information extracted from the request, without exposing any sensitive information about resources being requested and/or where they are stored in a system. Moreover, at least some of this sensitive information (e.g., private keys, access credentials, etc.) may be converted into a verified signature that is routed to the source of requested resources, ultimately creating a seamless and secure access channel to the desired resources.

The base server 210 supports signature based authentication and authorization procedures. The base server 210 is thereby preferably able to generate access signatures that are configured to represent a specific request on resource(s) or sub-resource(s). The access signatures may be generated using information received with the access request (e.g., an authenticated user identification) and/or associated with the requested resource(s) along with where and/or how they are stored. An access signature generated by the base server 210 may thereby be configured for a target resource (e.g., written in a given programming language, compatible with a given operating system, etc.), and valid for a specific time period. Generated access signatures as such allows servers that receive an access signature to identify specific URI, query parameters and/or expressions, the time period for which the request is valid, whether valid service credentials were used to create the signature, etc., without exposing any of this sensitive information to unverified locations. Thus, only server 220 is capable of deciphering an access signature generated by base server 210 and configured to access resources referenced in the access request.

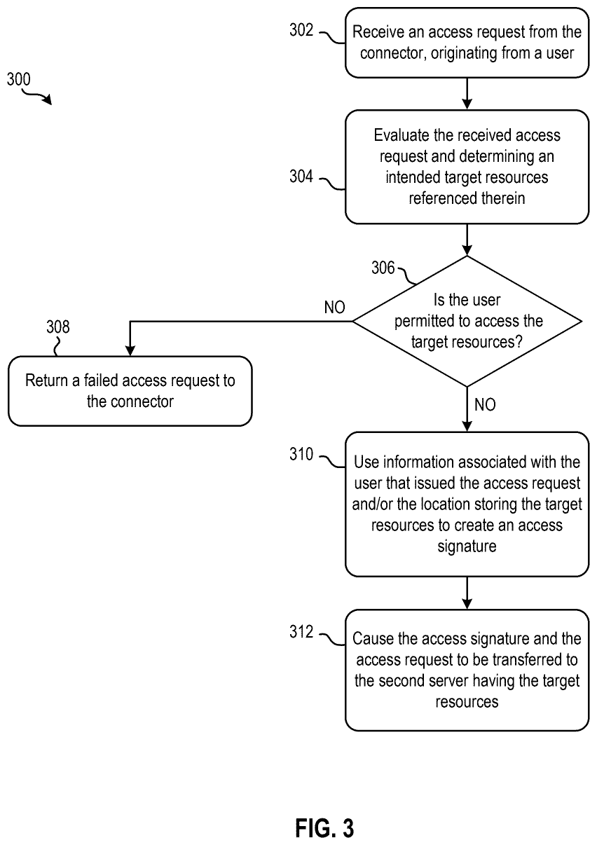

Looking now to FIG. 3, a flowchart of a computer-implemented method 300 for processing access requests to resources at specific locations without receiving any credentials and/or configuration information associated with the resources themselves, is illustrated in accordance with one approach. In other words, method 300 involves dynamically evaluating and verifying access requests that lack any sensitive information (e.g., storage location, security protocols, password(s), etc.) associated with the resources and/or where they are stored. Method 300 may be performed in accordance with the present invention in any of the environments depicted in FIGS. 1-2, among others, in various approaches. Of course, more or less operations than those specifically described in FIG. 3 may be included in method 300, as would be understood by one of skill in the art upon reading the present descriptions.

Each of the steps of the method 300 may be performed by any suitable component of the operating environment using known techniques and/or techniques that would become readily apparent to one skilled in the art upon reading the present disclosure. For example, one or more processors located at a base server of a distributed system (e.g., see processor 212 of base server 210 in FIG. 2 above) may be used to perform one or more of the operations in method 300. In other approaches, one or more operations of method 300 may be modified and performed by one or more processors located at a connector module separating users from a remainder of a distributed system (e.g., see processor 205 of connector module 204 in FIG. 2 above).

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a CPU, an application specific integrated circuit (ASIC), a field programmable gate array (FPGA), etc., combinations thereof, or any other suitable computing device known in the art.

As shown, operation 302 of method 300 includes receiving an access request from a connector, originating from a user. In some approaches, the access request originates from the user and is passed to a connector module. For example, the user may interact with one or more applications running locally at the user location and/or over a network connection to access (e.g., exchange information with) the connector module.

In response to receiving the access request, the connector module may evaluate the request and identify whether any target credentials are provided. In other words, while the access request may include details corresponding to the user that issued the request (e.g., an authenticated user identification correlated with the user), at least some access requests may be silent with respect to sensitive information (e.g., credentials) defining the desired resources and/or where the resources are held.

The connector module may inspect the request and determine whether any access credentials (e.g., private keys permitting access to referenced resources) are included therewith. In approaches where the access credentials (e.g., sensitive information) is known by a user attempting to gain access, the connector module may identify the credentials, and automatically establish a direct access channel to the referenced resources. For example, some users may be permitted to gain access to sensitive access credentials without introducing any security threats. However, in situations where the connector module identifies that an access request does not include any details (e.g., credentials or other sensitive information) used to establish and/or maintain access to specific resources and/or the location they are stored, the access request is forwarded to a base server. There, the base server is configured to process access requests that generally identify desired resources, but which do not include details that reference (e.g., credentials that cite to) the resources and/or where they are located.

Accordingly, method 300 advances from operation 302 to operation 304. There, operation 304 includes evaluating the received access request and determining an intended target resources referenced therein. Again, an access request may not include any credentials or other sensitive information used to establish and/or maintain access to specific resources and/or the location they are stored, the access request itself may generally reference the resources involved. For instance, the received access request may not include any information that specifies (e.g., references) a server that includes the target resources. According to an example, the user may issue a request to a connector that passes the request along with an authenticated identification corresponding to the user. However, it should be noted that no credentials associated with the target server are included in the request and/or provided by the user in general. The user may not even be aware of the server that holds the desired resources, thereby improving user experience in applications by reducing latency.

Rather, the access request may generally reference the desired resource. Operation 304 may thereby include comparing any information extracted from the access request to identify the specific resources, storage location, access path(s), etc. In some approaches, one or more AI based models trained to identify and/or facilitate dynamic resources in a distributed system may be used to evaluate the received access request as well as the current state of the system. In some approaches, protected lookup tables are referenced in order to identify specific details associated with resources and/or where they are stored.

From operation 304, method 300 advances to operation 306. There, operation 306 includes determining whether the user is permitted to access the target resources. In preferred approaches, determining whether the user is permitted to access the target resources is based at least in part on an output produced by an access policy engine. In other words, an access policy engine is referenced in order to determine whether the user that issued the access request is permitted to utilize the desired resources. The access policy engine preferably includes credentials of various servers and/or users that are connected to the base server. In some approaches, the process of accessing a network connecting the servers holding resources may involve providing identifying information. In other approaches, the process of adding a resource to a server or larger system may involve providing identifying characteristics. Accordingly, the policy engine may develop a repository of users, resources, storage locations, use constraints, etc. that are associated with a given system along with the logical and physical components included therein. In some approaches, the policy engine may include one or more AI based models that are trained to evaluate access requests and correlate details therein with known information about a system and/or the resources therein.

Method 300 advances from operation 306 to operation 308 in response to determining the requesting user is not permitted to access the target resources. In other words, method 300 advances to operation 308 in response to the policy engine evaluating all the details pertaining to a given access request, referenced resources, a source of the request, etc., and determining that the access request should not be permitted. In some approaches, access requests that violate one or more terms in one or more policies may be flagged as not being permitted. In other approaches, access requests received from users that have had a predetermined number of previous access requests denied and/or in a predetermined amount of time. There, operation 308 includes returning a failed access request to the connector. In other words, operation 308 includes failing the access request received in operation 302 and returning the result (failure) to a connector module that initially received the access request and directed it to the base server that may be performing method 300.

In some approaches, operation 308 may include sending one or more instructions to the connector module that cause some indication of the failed access request to be conveyed. For example, the base server may send instructions to the connector module that cause the module to send a warning that is displayed on the user's electronic device. In other approaches, the base server may instruct the connector module to block any access requests that are received from the same user for a predetermined amount of time, until one or more conditions are met, until a risk profile drops below a given threshold, etc. Moreover, failed access requests may be returned to an AI module in order to train and/or retrain AI based models therein to dynamically adapt to changes in access attempts.

However, returning to operation 306, method 300 advances to operation 310 in response to determining that the user is permitted to access the target resources. As noted above, access requests and the sources (e.g., users, applications, AI based models, micro-services, etc.) that issue them are preferably evaluated to determine whether accessing the desired resources is permitted. It follows that in some approaches, method 300 advances to operation 310 in response to a policy engine evaluating the details pertaining to a given access request, referenced resources, a source of the request, etc., and determining that the access request should be permitted. For example, the access request, resources, user that issued the request, etc. may include details (e.g., metadata, access patterns, security profiles, etc.) that can be compared against one or more policies to gauge compliance.

As shown, operation 310 includes using information associated with the user that issued the access request and/or the location storing the target resources to create an access signature. For example, in some approaches operation 310 includes using an authenticated user identification, along with credentials of a server storing (e.g., having) the desired target resources, to create an access signature. It follows that the access signature is configured to convey privileges of the user that are derived from (e.g., based on) a first system, and broker authorization in a second system without exposing sensitive details (e.g., credentials of the corresponding system) of the target server and/or the user that submitted the request.

Moreover, this is again achieved without the access request specifying (e.g., referencing) the server or location having the target resources. According to an example, the user may invoke a connector that passes an authenticated user ID to a base server for evaluation. In response to passing the evaluation, the base server generates an access signature for an access request that conveys the request has been interpreted and verified. This signature may thereby be used to provide the requesting user access to the desired resource(s) without exposing any sensitive information (e.g., credentials of the system) associated with the storage location(s) and/or the resources themselves. Again, the user does not provide any credentials of the target server. The user may thereby not even be aware of the target server, improving the user experience in approaches herein. According to one example, which is in no way intended to be limiting, the access signature created in operation 310 includes a SIGNATURE VERSION 4 signature. However, any type of signature that is able to convey sensitive information (e.g., credentials) to a location without exposing the sensitive information may be implemented. For example, an access signature may include any object (e.g., code) that encodes and encrypts information about the content or object being accessed. In some approaches, the access signature may include parameters, expressions, etc., such that only the server hosting the content will be able to decipher and verify access requests, e.g., as would be appreciated by one skilled in the art after reading the present description.

With continued reference to FIG. 3, method 300 advances from operation 310 to operation 312. There, operation 312 includes causing the access signature and the access request to be transferred to the second server having the target resources. In other words, operation 312 includes sending the access signature formed to convey the requesting user's ability (e.g., authorization) to access the desired resources, along with the credentials (e.g., general and/or security based details involved with actually gaining access to a particular resource). In preferred approaches, the process of causing the access signature to be transferred to the second server includes first transferring the actual access signature to the connector. For instance, the access signature may be transferred to a connector module that is configured to direct access requests to the intended target locations referenced in the respective access requests. As noted above, the connector module is also configured to initially evaluate access requests and direct generic ones (e.g. not having credentials or other sensitive information therein) to a base server. The base server may be configured to extract information about the source of the access request (e.g., the ID of the user from which the access request was received) and/or the intended target of the access request (e.g., a resource storage location, access passwords, secure IDs, etc.). In other words, the base server may be used to evaluate some access requests and inform the connector that the resource(s) requested are located at a particular destination (e.g., server). This may be used by the connector module to redirect the original access request to the destination having the desired resource(s).

In preferred approaches, redirect instructions are sent to the connector module along with the access signature that is formed. These redirect instructions ultimately cause the connector module to forward (or “redirect”) the access signature along to one or more locations (e.g., servers) that include the desired resources. In other words, the connector, in response to receiving the redirect instructions from the base server, sends at least a copy of the access request and the formed access signature to the server that contains the resources referenced in the access request. The connector module may thereby be configured to prevent users, applications, trained models, etc., from directly accessing any other physical and/or logical elements in the system without first providing authorization to do so. In essence, the connector module serves as an interface between the system storing resources being requested, and the entities (e.g., users, applications, models, etc.) that are requesting access to these resources.

In response to receiving the access signature, the target server preferably deciphers the access signature and determines whether it includes a valid request. In response to detecting a valid request, the target server locates the requested resource(s) and returns access to the contents to the connector. In turn, the connector transfers access to the user. In some approaches, the target server sends a copy of the desired resources to the requesting user. In other approaches, the target server sends an access channel that provides one location at a time access to a desired resource. It follows that performing operation 312 results in the source of the access request gaining access to the requested resource(s). As noted above, in some approaches a copy of the requested resource may be created (e.g., at the target server, at a central server, etc.) and sent to the requesting user in any desired format, arrangement, security configuration, etc.

It should also be noted that the term “resource” as used herein refers to any type of logical and/or physical component that may be used to perform certain operations and/or improve the efficiency at which certain operations may be performed. For instance, in preferred approaches a resource is a specific object that can be identified by a Uniform Resource Identifier (URI). In some approaches, a subset of the resources in a server may be accessed using an expression or query parameter in addition to the URI. According to different approaches, the resources that are included in a server may include text, media, binaries, trained models, etc., or any other access controlled resources that may be used to perform a data access request. For example, a user may issue a request for access to trained AI based models that are configured to receive inputs associated with performance and generate an output that identifies sources of issues in the inputs. The AI based models may thereby remove the inputs that are causing the issues, before re-evaluating the modified set of inputs to determine whether one or more of the issues have been resolved and/or performance of computers in the system operate more efficiently as a whole.

Again, by modifying the process by which resources are accessed, approaches herein are desirably able to establish and maintain verified access to resources without actively including any resource credentials and/or details. As noted above, approaches herein are able to satisfy access requests to specific target servers from authenticated users and maintain connections thereto without receiving specific configuration information about the target servers from the users. This allows for a base server to perform access signature calculation quickly and efficiently, allowing for the base server to be scaled significantly. For example, through testing with object storage based servers, the inventors discovered that a base server having only a single CPU is still capable of evaluating and satisfying (where appropriate) millions of resource requests.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to evaluate access requests, extract identifying information, determine whether the requests are permitted by one or more policies, and generate a signature that securely conveys this information without exposing it. Initial training may include reward feedback that may, in some approaches, be implemented using a known data set and/or weighted entries. However, to prevent costs associated with relying known data sets, another approach includes reward feedback implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with facilitating access requests, because the neuromyotonic AI model may iteratively apply training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from permitted and rejected access requests. Such an AI model ensures that access requests are performed securely and without sacrificing system security, where the scale of such analysis and determinations would not otherwise be feasible for a human to perform. This is because humans are not able to efficiently evaluate the various details of a requesting user, correlate those details with secure (e.g., hidden) credentials associated with accessing resources and/or security levels of the users themselves, and generate signatures that convey the information associated with accessing the requested resources, and would otherwise incorporate processing delays and errors in the process of attempting to do so. Accordingly, management of operations described herein is not able to be achieved by human manual actions.

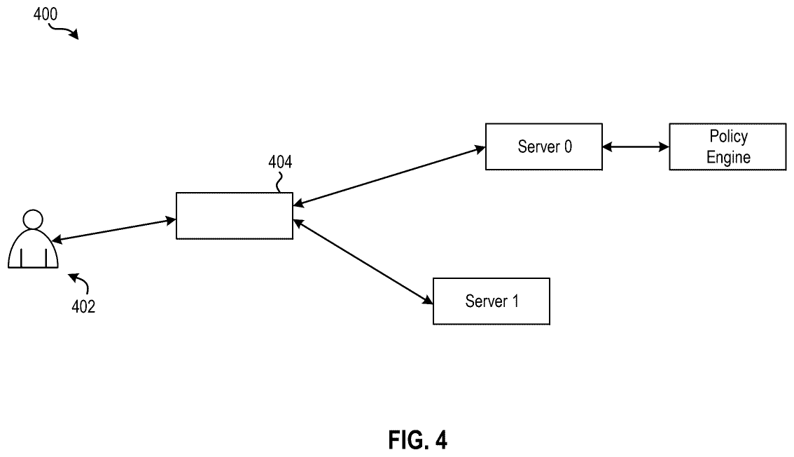

Looking now to FIG. 4, a system 400 configured to process access requests to resources at specific locations in a system without receiving any credentials and/or configuration information associated with the resources themselves, is illustrated according to an in-use example which is in no way intended to be limiting. In other words, the system 400 is configured to dynamically evaluate and verify access requests that lack any sensitive information (e.g., storage location, security protocols, password(s), credentials, etc.) associated with the resources being requested and/or where they are stored. It should be noted that while the in-use example of FIG. 4 is presented in the context of an AMAZON SIMPLE STORAGE SERVICE (S3) based system, this is by way of example only and is in no way intended to be limiting. Rather, any of the approaches herein may be modified for any desired type of system, e.g., as would be appreciated by one skilled in the art after reading the present description.

As shown, the S3 based system 400 includes a client 402 that is connected to a connector module 404. The connector module 404 is further connected to a base server “Server-0 ” along with a target server “Server 1”. The baser server “Server-0 ” is additionally connected to a Policy Engine.

The connector module 404 effectively serves as an additional system (e.g., sub-system) that divides the client 402 from desired resources (e.g., services) in target server “Server 1”. Importantly, the connector module 404 acts as a broker of authorization while implementing very little control traffic and virtually no data traffic.

For example, the process of reading and/or writing data by submitting access requests may be performed despite the access requests lacking any access credentials for the S3 based target server “Server 1” that contains the resource(s) the request is ultimately targeting. This may be achieved by the client 402 (e.g., on behalf of a user) issuing a request to access one or more specific objects and/or portions thereof. The request is received at a S3 based proxy which may be hosted at the connector module 404 and/or the base server “Server-0” depending on the approach. While the S3 based proxy has access to the actual credentials that are involved with authorizing the access request, it is running in a controlled environment, to which the client 402 does not have access. Thus, there is no threat of compromising the associated credentials. The S3 based proxy optionally reaches out to an authorization system to find out if the requesting client 402 should be able to access the requested resource (e.g., object or portion thereof). In response to determining the client 402 is able to access the requested resource, the S3 based proxy redirects the original access request from client 402 to the actual target server “Server 1”, in addition to adding additional information in the access request. For instance, the additional information may be sufficient for the S3 based target server “Server 1” to accept the request and serve the requested resource. Thus, the S3 proxy acts as an authorization broker that permits verified users, applications, models, etc., to access data without ever exchanging actual credentials associated with doing so. Moreover, because the S3 proxy is only involved in the authorization brokering, it does not impact data access rates. The actual data transfer, which may be few Gigabytes to several Terabytes can still happen between the client 402 and the S3 based target server “Server 1”.

Approaches herein are also able to allow multiple clients to access (e.g., fetch) large amounts of data from servers in parallel, even despite none of the clients having credentials to access the servers containing the data. Moreover, this is achieved without making any changes to server code or client code, and without negatively impacting performance. It should also be noted that these improvements are achieved without redirecting the object data to be processed through other systems. Approaches herein also achieve the ability to restrict data (e.g., resource) access on the subset level, which is beyond the granularity achievable by the access restriction provided by the original server. Data access may also be managed by another system other than and/or in addition to the original server that processed the access request.

According to another in-use example, which again is in no way intended to be limiting, in a lakehouse set up (e.g., wxd), an administrator registers a catalog “C” and brings a new S3 bucket “B”, which has the data for the relational tables “T1” and “T2” in the catalog “C”. Table data for T1 is in “/bucket-B/table/T1” and data for T2 is in “/buckets-B/table/T2”. Accordingly, the administrator adds a Spark engine “E” to wxd., and provides HMAC keys to access S3 buckets, which are stored in wxd. The administrator also adds another user “X” to wxd and provides access to table T1 in catalog C. However, user X has no credentials to access bucket B. User X runs a spark application from within wxd, where user X runs a query on table T1 and provides their identity (e.g., authenticated user identification) to launch a spark job. The spark job requires access to objects under “/bucket-B/table/T1/” to successfully run the spark job. However, the user does not have access to bucket B simply using their own identity.

S3 compatible object stores may include a S3 proxy+id-broker component which understands the identity of a requesting user and also has access credentials (e.g., HMAC) of various object storage buckets. In this example, the requesting user may direct their request to a S3 proxy by setting an end point to the proxy's end point. The user may set their identity (e.g., API key) as a spark configuration, e.g., to access buckets. The user's spark application may further reach the S3 proxy in order to read S3 objects. The app uses an S3 driver (e.g., STOCATOR) to access S3 objects. This driver may use the credential provided to calculate an authorization header in such approaches.

In response to receiving a request, the S3 proxy verifies the request came from a known user, in addition to identifying which object or part of object the user requested. The S3 proxy may consult an access policy engine to find out if the requesting user has access to the requested data. If the answer is no, the request is rejected with a 403 error, e.g., as per S3 specifications. However, if the user does have access to the object or part of the object requested, the S3 proxy accesses the credentials for the bucket the desired object is in. It then calculates an authorization header (e.g., access signature) for the requested object. The validity for the authorization header may be set to a relatively short period of time, e.g., such as 1, 2, 3, 4, 5, 7, 9, 10, 13, 15, 16, 19, 20, 30, 40 seconds, minutes, hours, days, etc., but could be longer or shorter. In turn, the spark application (e.g., s3 driver) sends a request to the redirected URL with the valid authorization.

The actual S3 endpoint checks the signature and permits the request in situations where the signature is valid. Thus, even without having access to credentials for the S3 bucket, a user is able to access desired resources. Even in situations where a user nefariously hack the system and obtains the access signature for other users, this only permits the bad actor to see the data for the specific file or portion thereof and only during the validity period. Approaches herein make use of that fact that the signature contains specific information (e.g., the object URL, query parameters, etc.) to identify issues.

Again, approaches herein are capable of understanding privileges of users in one system (e.g., spark), and brokering authorization into another system (e.g., S3), without passing actual credentials between the systems. At least some of these approaches utilize the fact that signatures are created based on the resources (e.g., object) that is requested, the query parameters, and timing. Moreover, they are created for target systems with limited validity periods. Approaches may achieve directing (e.g., re-directing) access signatures from a base server that formed the signature, to a target server having the requested resources, without involving the requesting user. Rather, the connector may be utilized to seamlessly facilitate the user's access to the requested resources. In some approaches, HTTP re-direct is used. In other approaches, a conduit of data (e.g., gateway) may be used to provide access.

Some approaches are desirably able to implement base servers that perform the authentication of access requests rather than simply reading and relaying resources that are requested. In other words, the base server handles the authentication and lets the originating connector facilitate a connection to the actual server having the requested resource(s). Approaches here may thereby be loaded and performed with very little impact to compute overhead, thereby allowing for thousands, tens-of-thousands, etc., of access requests to be processed without negatively impacting system performance.

Thus, even in situations where a user, program, application, model, etc. does not have access to credentials involved with gaining access to desired resources in a system, these credentials may be codified in one or more policies (e.g., AI based models). Thus, approaches herein enable a user to access resources without providing any of the credentials that may be associated with doing so.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
receiving, at a base server from a connector, an access request originating from a user, wherein the access request includes an authenticated user identification correlated with the user;
evaluating the received access request and determining target resources;
determining whether the user is permitted to access the target resources;
in response to determining the user is permitted to access the target resources, using the authenticated user identification and credentials of a second server storing the target resources to create an access signature; and
causing the access signature and the access request to be transferred to the second server having the target resources.

2. The method of claim 1, wherein the causing the access signature to be transferred to the second server includes:
transferring the access signature to the connector; and
causing the access signature to be redirected to the second server.

3. The method of claim 1, wherein the access request does not include details that reference the second server.

4. The method of claim 3, wherein the access signature is configured to convey privileges of the user that are derived from a first system, and broker authorization in a second system without exposing the credentials of the second system.

5. The method of claim 4, wherein the determining whether the user is permitted to access the target resources is based at least in part on an output produced by an access policy engine.

6. The method of claim 5, wherein the access policy engine includes credentials of various servers and/or users that are connected to the base server.

7. The method of claim 1, further comprising:
in response to determining the user is not permitted to access the target resources, returning a failed access request to the connector.

8. The method of claim 1, wherein the connector is configured to prevent the user from directly accessing the base server and/or the second server.

9. A computer program product comprising:
one or more computer readable storage media; and
program instructions stored on the one or more storage media to perform operations comprising:
receiving, at a base server from a connector, an access request originating from a user, wherein the access request includes an authenticated user identification correlated with the user;
evaluating the received access request and determining target resources;
determining whether the user is permitted to access the target resources;
in response to determining the user is permitted to access the target resources, using the authenticated user identification and credentials of a second server storing the target resources to create an access signature; and
causing the access signature and the access request to be transferred to the second server having the target resources.

10. The computer program product of claim 9, wherein the causing the access signature to be transferred to the second server includes:
transferring the access signature to the connector; and
causing the access signature to be redirected to the second server.

11. The computer program product of claim 9, wherein the access request does not include details that reference the second server.

12. The computer program product of claim 11, wherein the access signature is configured to convey privileges of the user that are derived from a first system, and broker authorization in a second system without exposing the credentials of the second system.

13. The computer program product of claim 12, wherein the determining whether the user is permitted to access the target resources is based at least in part on an output produced by an access policy engine.

14. The computer program product of claim 13, wherein the access policy engine includes credentials of various servers and/or users that are connected to the base server.

15. The computer program product of claim 9, wherein the operations further comprise:
in response to determining the user is not permitted to access the target resources, returning a failed access request to the connector.

16. The computer program product of claim 9, wherein the connector is configured to prevent the user from directly accessing the base server and/or the second server.

17. A computer system comprising:
a processor set;
one or more computer readable storage media; and
program instructions stored on the one or more storage media to cause the processor set to perform operations comprising:
receiving, at a base server from a connector, an access request originating from a user, wherein the access request includes an authenticated user identification correlated with the user;
evaluating the received access request and determining target resources;
determining whether the user is permitted to access the target resources;
in response to determining the user is permitted to access the target resources, using the authenticated user identification and credentials of a second server storing the target resources to create an access signature; and
causing the access signature and the access request to be transferred to the second server having the target resources.

18. The computer system of claim 17, wherein the access request does not include details that reference the second server.

19. The computer system of claim 18, wherein the access signature is configured to convey privileges of the user that are derived from a first system, and broker authorization in a second system without exposing the credentials of the second system.

20. The computer system of claim 17, wherein the connector is configured to prevent the user from directly accessing the base server and/or the second server.
